(19) United States
(12) Patent Application Publication
(10) Pub. No.: US 2007/0124945 A1
(43) Pub. Date: Jun. 7, 2007

(54) Scissors having rustproof blades

(75) Inventor: Akira Hirai, Kawaguchi-shi (JP)

Correspondence Address: HAMRE, SCHUMANN, MUELLER & LARSON, P.C., P.O. BOX 2902, MINNEAPOLIS, MN, 55402-0902, US

(73) Assignee: KUSANAGI RYOTA, Kawaguchi-shi (JP)

(21) Appl. No.: 11/541,972

(22) Filed: Oct. 2, 2006

(30) Foreign Application Priority Data
Dec. 1, 2005 (JP) 2005-347656

(51) Int. Cl. B26B 13/28; B26B 9/00

(52) U.S. Cl. 30/350; 30/266

(57) ABSTRACT

When ceramic is used for blades of scissors, shear stress is concentrated on a pivot, and when the blades are fixed by a typical metal bolt, the bolt becomes worn out causing the scissors to rattle, due to the ceramic having hardness larger than the metal bolt, which affects the durability of the scissors.

The present invention provides a pair of scissors 1 that includes a pivot 2 rotatably supporting top and bottom blades 1A and 1B, in which the blades 1A and 1B are made of a sintered ceramic, through holes 1Aa and 1Ba are formed at the pivot 2, a ceramic ring 2a is rotatably inserted in the through holes 1Aa and 1Ba, a fixing shaft 2a passes through the ceramic ring 2a to be fixed, and the ceramic ring 2a contains CuO.

### BACKGROUND OF THE INVENTION

1. Field of the Invention

The present invention relates to a pair of scissors including rustproof top and bottom blades and a pivot rotatably supporting the blades to cut a material by a shearing operation between the blades, more particularly, to a pair of scissors in which top and bottom blades are formed of a rustproof metal and a ceramic ring is inserted into the pivot to increase the durability.

2. Description of the Related Art

In the related art, a pair of scissors is used for cutting a material, such as a sheet, and also for various purposes such as gardening, cooking, etc. A thread fastening means using a bolt is widely used as a fixing mechanism at a pivot. However, since a thread fastening force affects the opening/closing force during cutting a material, when a bolt is firmly fastened so as to prevent loosening, the two blades become too close due to the thread-fastening force to operate. Accordingly, a method using a shoulder screw to fix a fastening position has been used.

However, when a ceramic is used for blades of scissors, the shear stress of the scissors is concentrated on the pivot. When the blades are fixed by a typical metal bolt, a hardness of the ceramic is larger than that of the metal bolt. Therefore, the bolt becomes worn out, which causes the scissors to rattle, and affects the durability of the scissors. Further, the metal bolt is worn out and rusted allowing rust to adhere to the ceramic blades, which affects the appearance and maintenance of sanitation of the ceramic that is esthetic in itself.

For example, in JP-A-61-112780, a pair of mid-fastening type scissors having a shaft 2 serving as a supporting point for two blades 1a and 1b that is disposed in the middle point of pressing points 3a and 3b pressed by hands and the two blades 1a and 1b is disclosed. In this mid-fastening type scissors, a ring 4 through which the shaft 2 passes is inserted through the blades 1a and 1b and fixed to one of the blades 1a and 1b, and the thickness of the ring 4 increases towards the pressing points 3a and 3b from the ends (the front) of the blades 1a and 1b, furthermore, the blades 1a and 1b are made of a ceramic and the ring 4 is made of a rubber. In JP-A-2-52684, it is disclosed that a pair of scissors is configured such that first and second members rotatably supported by a shaft cut a material using shear force resulting from their interaction. In this case, the first and second members are made of ceramic and a relief part is formed by leaving a sliding surface on a cutting blade. In JP-A-2004-527360, it is disclosed that a bipolar clamp 10 includes two scissors parts 12 and 14 that are mechanically connected by an insulating bolt or a pivot joint 16 and rotatable with respect to each other and electrically insulated from each other, electrode parts 18 and 20 that are disposed at the front ends 22 and 24 of the scissors part 12 and 14 for grasping tissue and for conducting coagulation current through the tissue, handles 26 and 28 that are disposed at the rear ends 30 and 32 of the scissors part 12 and 14, current supply means 34, 40, 42 that are disposed at the rear end 32 of the scissors part 14, and locking means 36 and 38 that are disposed between the pivot joint 16 and the rear ends 32 and 34 and lock the scissors parts 12 and 14 at the closing position. According to the bipolar clamp 10, the current supply means 34, 40, 42 and the locking means 36 and 38 are configured such that electric current flows through the electrodes 18 and 20 only at the closing position by the current supply means 34, 40, 42. According to the above configuration, because the coagulation current does not flow until the clamp reaches the closing position, the bipolar clamps are safely operated. Furthermore, the insulating pivot joint 16 has a pin 46 as a rotational shaft and particularly the pin 46 is provided inside the clamp 12 in a ceramic insulating socket 44.

### SUMMARY OF THE INVENTION

However, as for the scissors disclosed in JP-A-61-112780, the two blades 1a and 1b are made of ceramic and the ring 4 is made of rubber. In this case, since the ring 4 does not pass through the ceramic blades 1a and 1b, a recess in which the ring is fitted is formed, as shown in the drawings, on the surface where the blades 1a and 1b come in contact. As for the scissors disclosed in JP-A-2-52684, since the first and second members are also made of ceramic and the relief part is formed by leaving a sliding surface on the cutting blade, rattling caused by abrasion of the metal bolt cannot be prevented.

Furthermore, as for the bipolar clamp 10 disclosed in JP-A-2004-527360 that is similar to a pair of scissors in the configuration, since two blades 12 and 14 are mechanically connected by an insulating bolt or a pivot joint 16, the insulating pivot joint 16 has a pin 46 as a rotational shaft and the pin 46 is provided in one clamp 12 of the insulating ceramic socket 44, the insulating ceramic socket 44, as shown in FIG. 3, does not pass through both blades 12 and 14 and is provided to maintain the insulation between the blades 12 and 14, thus the configuration, object, operation, and effect are different from those of the scissors according to embodiments of the invention.

In order to overcome the above problems, a pair of scissors having rustproof blades according to the embodiment of the invention includes a pivot rotatably supporting top and bottom blades to cut a material by the blades' reciprocal shearing, in which the blades are made of Ti alloy or sintered ceramic having Vickers hardness of 1000 Hv or more, through holes are formed at the pivot, a ceramic ring is rotatably inserted in the through holes, a fixing shaft passes through the ceramic ring to be fixed, and the ceramic ring contains CuO to improve antibiotic function.

### BRIEF DESCRIPTION OF THE DRAWINGS

The above and other features and advantages of the present invention will become more apparent by describing in detail preferred embodiments thereof with reference to the attached drawings in which:

FIG. 1 is a plan view of a pair of scissors having rustproof blades according to an embodiment of the invention;

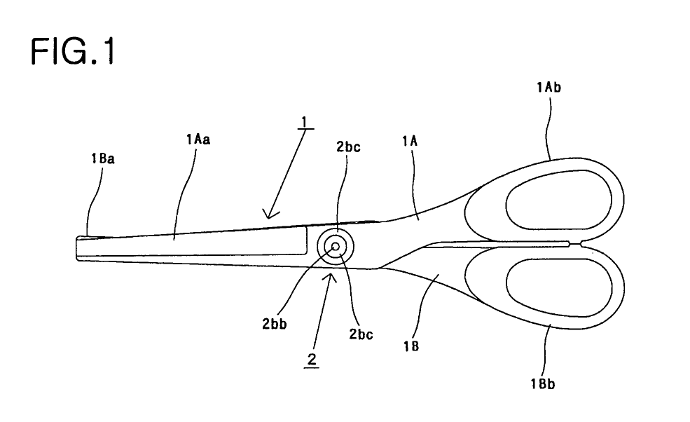

FIG. 2 is a cross-sectional view of main parts of a pair of scissors having rustproof blades according to an embodiment of the invention; and

FIG. 3 is a plan view of a ceramic ring of a pair of scissors having rustproof blades according to an embodiment of the invention.

### DESCRIPTION OF THE PREFERRED EMBODIMENTS

Hereinafter, detailed description will be given of a pair of antirusting scissors according to an embodiment of the present invention with reference to accompanying drawings.

The present invention relates to a pair of scissors including rustproof top and bottom blades 1A and 1B and a pivot 2 rotatably supporting the blades to cut a material by a shearing operation between the two blades, in particular, to a pair of scissors in which top and bottom blades are formed of a rustproof metal and a ceramic ring 2a is inserted in the pivot to increase the durability. According to an embodiment of the invention, a pair of scissors 1 includes a pivot 2 rotatably supporting the top and bottom blades 1A and 1B to cut a material by using shearing operation between the blades. In this case, the blades 1A and 1B are formed of a Ti alloy, through holes 1Aa and 1Ba are formed at each pivot 2, and the ceramic ring 2a is rotatably inserted in the through holes 1Aa and 1Ba while a fixing shaft 2b passes through the ceramic ring 2a so as to be fixed.

According to another embodiment of the invention, a pair of scissors 1 includes a pivot 2 rotatably supporting the top and bottom blades 1A and 1B to cut a material by shearing operation between the blades. The blades 1A and 1B are made of a sintered ceramic having Vickers hardness of 1000 Hv or more, through holes 1Aa and 1Ba are formed at the pivot 2, and a ceramic ring 2a is rotatably inserted in each of the through holes 1Aa and 1Ba, while a fixing shaft 2b passes through the ceramic ring 2a so as to be fixed.

According to another embodiment of the invention, in the above-mentioned scissors, the ceramic ring 2a contains CuO to maintain an antibiotic function.

Known scissors generally use quench-hardened blades, but a fixing shaft that is inserted into through holes formed through blades for different types of scissors for gardening, cooking, etc. is generally formed of a material having hardness lower than the blades. Because the entire shear stress in the scissors is applied to the fixing shaft, as the scissors are used repeatedly, the fixing shaft is worn out by sliding between the fixing shaft and the inner surfaces of the through holes of the blades having higher hardness than the fixing shaft, which causes rattling. As a result, the gap between the two blades is increased and thus it becomes difficult to cut material with the scissors.

When a pair of scissors is used for cutting plants such as garden shears or for cutting meat, etc. such as cooking scissors, acid, base, or salt contained in sap or meat juice exuded by cutting permeates into the pivot of the two blades and corrodes or rusts the blades and the fixing shaft, so that they shorten the durability of the scissors. In addition, the pivot of the scissors is exposed to an unsanitary environment where various bacteria can easily propagate due to remaining water or sap. Therefore, scissors having rustproof blades according to an embodiment of the invention is provided to increase the durability while keeping the pivot sanitized, which are the most important parts in the structure of the scissors.

The scissors according to an embodiment of the invention includes rustproof top and bottom blades 1A and 1B that are longitudinally provided with cutting portions 1Aa and 1Bb for cutting a material, handles 1Ac and 1BC that are provided at the ends of the blades for holding and providing shear force to the cutting portions, and a pivot 2 that are formed in the middle portion of each blade where the blades symmetrically cross to rotatably support the blades.

The top and bottom blades 1A and 1B are made of a Ti alloy and through holes 1Aa and 1Ba into which a ceramic ring 2a (described below) is inserted are formed at each pivot 2.

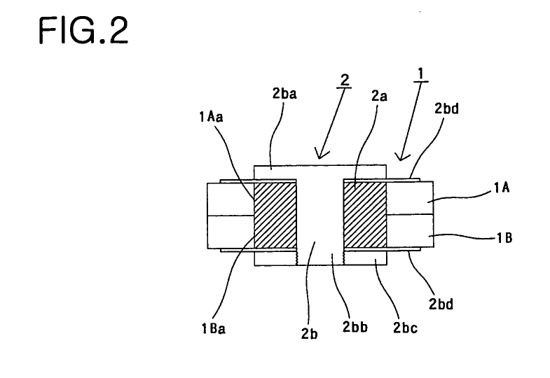

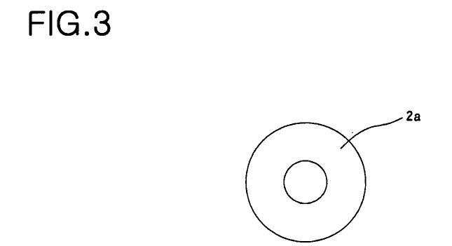

As shown in FIGS. 2 and 3, the ceramic ring 2a is a ring made of a ceramic having inner and outer diameters, whose thickness is the same or larger than the sum of the thicknesses of the top and bottom blades 1A and 1B at the pivot. Further, the outer diameter of the ceramic ring is smaller than the inner diameters of the through holes 1Aa and 1Ba, and the fixing shaft 2b (described below) can pass through the inner diameter of the ceramic ring.

The through holes 1Aa and 1Ba are formed through the top and bottom blades 1A and 1B, respectively, and the ceramic ring 2a is inserted into the through holes.

The fixing shaft 2b passes through the ceramic ring 2a inserted in the through holes 1Aa and 1Ba of the top and bottom blades 1A and 1B so as to be fixed thereto. In the present embodiment, a shaft portion 2bb protrudes from the center of a circular plate flange 2ba and is fixed by a nut 2bc that is fastened to the screw threaded at the end portion of the shaft portion 2bb, and flat washers 2bd are interposed between the flange 2ba and the top blade 1A, and the nut 2bc and the bottom blade 1B. However, the fixing shaft 2b is not specifically limited to the above-mentioned shaft as long as the shaft passes through the ceramic ring 2a.

According to another embodiment of the invention, the top and bottom blades 1A and 1B are made of a sintered ceramic having Vickers hardness of 1000 Hv or more instead of a Ti alloy, and the other characteristics are the same as in the above embodiment, thus the description will be omitted.

Further, the ceramic ring 2a may contain CuO that has an antibiotic function as well-known in the art to add the antibiotic function to the pivot 2 which are easily dirty.

The hardness of the blades made of a carbon steel of known scissors depends on the manufacturing conditions, and the Vickers hardness thereof is generally 800 Hv or less, while the Vickers hardness of a fixing shaft used in related art is 500 Hv or less. However, Vickers hardness of alumina ceramic for the ceramic ring 2a according to the embodiments of the invention, i.e. 1200 Hv or more and Vickers hardness of oxidized zirconium ceramic is 1600 Hv or more, which are considerably larger than that of known blades. Therefore, abrasion due to sliding on the insides of the top and bottom blades 1A and 1B at the pivot is not caused in the ceramic ring 2a.

The hardness of the Ti alloy used for the top and bottom blades 1A and 1B according to the embodiments of the invention, which has a rustproof characteristic, is substantially the same as carbon steel and 800 Hv or less, thus does not wear out the ceramic ring 2a.

The ceramic ring 2a is mainly formed of a sintering-bonded structure of sub micron particles and the surface after the sintering-bonding is smooth and does not cause abrasion and sticking due to sliding on a metal surface, thereby allowing the ring to maintain accuracy for a very long time due to corrosion resistance. Further, when the ceramic ring 2a is used, the inner diameter of the ring is larger than the fixing shaft 2b passing through the ring, as a result the shear stress is dispersed due to the diameter being larger than the shaft. Accordingly, the abrasion is reduced by the increased diameters of the through holes 1Aa and 1Ba and the ceramic ring 2a.

Because the fixing shaft 2b just fixes both ends of the ceramic ring 2a, it does not affect the gap, i.e. clearance, between the top and bottom blades 1A and 1B. Further, because the fixing shaft 2a is securely fastened to the ends of the ceramic ring 2a regardless of the thread-fastening position unlike the scissors in the related art, it does not become to loose and is useful to maintain the shearing capability of the scissors. Furthermore, the antibiotic treatment of the ceramic ring 2a is effective in use of cutting food.

According to the scissors having rustproof blades of the invention, the ceramic ring used for the pivot has a rustproof characteristic and a considerably higher hardness, as compared with the metal of the blades or the fixing shaft, the blades are made of rustproof material, such as a Ti alloy or stainless steel, and the entire scissors is made of an rustproof material, so that the hardness of the ring and the scissors' durability can be increased.

According to the scissors of the invention, the ceramic ring used for the pivot has high hardness, as compared with the metal of the blades or the fixing shaft and rustproof characteristic, so that it is not easily worn due to high hardness and also not corroded by acid, alkali, or salt from general usage. Further, because the blades are made of a rustproof Ti alloy or sintered ceramic and the ring used for the pivot is also made of a ceramic and the entire scissors are made of a rustproof material, the ring has high hardness and the durability of the scissors can be increased.

Furthermore, the ceramic ring containing CuO prevents contamination from various bacteria, so that sanitation is improved and a pair of remarkably practical scissors is achieved.

1. A pair of scissors that includes rustproof top and bottom blades and a pivot rotatably supporting the blades to cut a material by reciprocal shearing operation of the blades,
wherein the blades are made of a Ti alloy, through holes are formed at the pivot, a ceramic ring is rotatably inserted in the through holes, and a fixing shaft passes through the ceramic ring to be fixed.

2. A pair of scissors that includes rustproof top and bottom blades and a pivot rotatably supporting the blades to cut a material by reciprocal shearing operation of the blades,
wherein the blades are made of a sintered ceramic having Vickers hardness of 1000 Hv or more, through holes are formed at the pivot, a ceramic ring is rotatably inserted in the through holes, and a fixing shaft passes through the ceramic ring to be fixed.

3. The scissors as set forth in claim 1,
wherein the ceramic ring contains CuO to provide an antibiotic function.

4. The scissors as set forth in claim 2,
wherein the ceramic ring contains CuO to provide an antibiotic function.
